(19) United States
(12) Patent Application Publication
(10) Pub. No.: US 2009/0262972 A1
(43) Pub. Date: Oct. 22, 2009

(54) SPEAKER AND DEVICE USING THIS SPEAKER

(75) Inventor: Takafumi Yuasa, Mie (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/569,091

(22) PCT Filed: May 16, 2005
(86) PCT No.: PCT/JP05/08869

§ 371 Date: Nov. 14, 2006

(30) Foreign Application Priority Data
May 19, 2004 (JP) 2004-148666

(51) Int. Cl. H04R 1/00

(52) U.S. Cl. 381/412; 381/86

(57) ABSTRACT

A speaker of the present invention includes a frame at which a magnetic circuit is mounted, a voice coil, an arched diaphragm, and an edge made of material different from that of the diaphragm. A part of the voice coil is disposed at a magnetic gap formed by the magnetic circuit. The diaphragm is coupled with the voice coil, and the edge links the diaphragm with the frame. Further, the diaphragm includes an inner-diameter-fixing part to be joined with the voice coil, an outer-diameter-fixing part to be joined with the edge, and a top part formed between the inner-diameter-fixing part and the outer-diameter-fixing part to protrude forward. A part near the top part differs from a part other than the part near the top part of the diaphragm in at least one of thickness and density. This structure flattened sound-pressure-frequency characteristic over broad bands.

### TECHNICAL FIELD

The present invention relates to a speaker used in various acoustic devices or image devices, an electric device such as a stereo system or a TV set and a device of an automobile or the like.

### BACKGROUND ART

As a conventional method for extending a high threshold frequency of a speaker, a method described in “SPEAKER SYSTEM vol. 1 pp. 157-158 written and edited by Takeo Yamamoto and published by Radio Technology Company (International Standard Book Number: ISBN4844301144)” (hereinafter referred to as “document 1”) is well-known. According to the document 1, an effective method is, for example, as follows: 1. Making a vibration-system-base mass light; 2. Using a diaphragm having high stiffness; 3. Making a half apical angle of a diaphragm small at a joining portion between the diaphragm and a voice coil.

However, the vibration-system-base mass such as the diaphragm or the voice coil becomes lighter, strength of the diaphragm decreases. Therefore, dividing resonance of the diaphragm tends to be generated, and a lot of large peaks and dips occur at a sound-pressure-frequency characteristic of the speaker. Moreover, durability against input signals can not be high.

In general, high stiffness material has a small internal loss, and large peaks and dips occur at its sound-pressure-frequency characteristic. Furthermore, when the half apical angle becomes small, gentle-and-large peaks and dips occur at the sound-pressure-frequency characteristic of anterior-chamber effect of the diaphragm.

FIG. 13 is a sectional view of the conventional speaker. According to FIG. 13, diaphragm 101 is fixed to frame 105 at its outer periphery, and fixed to voice coil 103 at its inner periphery. Half apical angle θ₂ which is an angle coupling diaphragm 101 with voice coil 103 is not larger than 45 degrees. An outer periphery part of voice coil 103 is held at its center by damper 104. Further, damper 104 is fixed to frame 105. Still further, center cap 102 is fixed to a top part of voice coil 103.

Yet further, field magnet part 107 structured by a plate, a magnet and a yoke is disposed at a bottom of frame 105.

Because half apical angle θ of conventional speaker 100 structured mentioned above is small (i.e., not larger than 45 degrees), gentle-and-large peaks and dips occur at the sound-pressure-frequency characteristic.

The conventional speaker is, for example, disclosed in Unexamined Japanese Patent Publication No. H11-313390.

### SUMMARY OF THE INVENTION

A speaker of the present invention includes a frame at which a magnetic circuit is mounted, a voice coil, an arched diaphragm, and an edge made of material different from that of the diaphragm. A part of the voice coil is disposed at a magnetic gap formed by the magnetic circuit. The diaphragm is coupled with the voice coil, and the edge links the diaphragm with the frame. Further, the diaphragm includes an inner-diameter-fixing part to be joined with the voice coil, an outer-diameter-fixing part to be joined with the edge, and a top part formed between the inner-diameter-fixing part and the outer-diameter-fixing part to protrude forward. A part near the top part differs from a part other than the part near the top part of the diaphragm in at least one of thickness and density. Using the structure discussed above, the speaker having a flat sound-pressure-frequency characteristic ranging over broad bands can be realized.

### BRIEF DESCRIPTION OF THE DRAWINGS

FIG. 1 is a sectional view of a speaker in accordance with a first exemplary embodiment of the present invention.

FIG. 2 is a characteristic view showing sound-pressure-frequency characteristics of the speaker shown in FIG. 1 and a conventional speaker.

FIG. 3A is a partially sectional view of the diaphragm which has another shape and can be used in the speaker shown in FIG. 1.

FIG. 3B is a partially sectional view of the diaphragm which has another shape and can be used in the speaker shown in FIG. 1.

FIG. 3C is a partially sectional view of the diaphragm which has another shape and can be used in the speaker shown in FIG. 1.

FIG. 3D is a partially sectional view of the diaphragm which has another shape and can be used in the speaker shown in FIG. 1.

FIG. 4 is a partially sectional view of the diaphragm which has another shape and can be used in the speaker shown in FIG. 1.

FIG. 5 is a plan view of the speaker using the diaphragm having another shape.

FIG. 6 is a plan view of the speaker using the diaphragm having another shape.

FIG. 7 is a plan view of the speaker using the diaphragm having another shape.

FIG. 8 is a plan view of the speaker using the diaphragm having another shape.

FIG. 9 is a sectional view of a speaker module in accordance with a second exemplary embodiment of the present invention.

FIG. 10 is an outline view of an electric device in accordance with a third exemplary embodiment of the present invention.

FIG. 11 is a sectional view of a device in accordance with a fourth exemplary embodiment of the present invention.

FIG. 12 is a schematic diagram of the speaker showing relation between high threshold frequency Fh and half apical angle θ.

FIG. 13 is a sectional view of the conventional speaker.

### REFERENCE MARKS IN THE DRAWINGS

1 diaphragm
1A inner-diameter-fixing part
1B outer-diameter-fixing part
1C top part of the diaphragm
1D part near the top part
2 center cap
3 voice coil
3A voice loading coil
4 damper
5 frame
6 edge
7 field magnet part
8 magnetic gap
30 speaker
40 electronic circuit
41 circuit board
42 electronic component
43 amplifier circuit
50 speaker module
51 enclosure
52 amplifier
53 player
54 mini component system
55 speaker system
56 main body
60 automobile
61 rear tray
62 front panel
63 driving member
64 steering
65 body
66 front wheel
67 rear wheel
68 seat
100 speaker
101 diaphragm
102 center cap
103 voice coil
104 damper
105 frame
106 edge
107 field magnet part

### PREFERRED EMBODIMENTS FOR CARRYING OUT THE INVENTION

Exemplary embodiments of the present invention are demonstrated hereinafter with reference to the accompanying drawings.

### FIRST EXEMPLARY EMBODIMENT

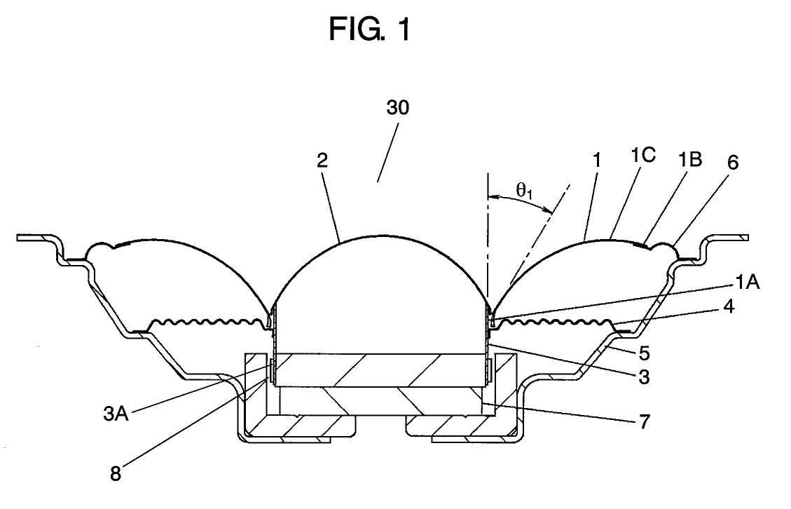

FIG. 1 is a sectional view showing a structure of a speaker in the first exemplary embodiment.

As shown in FIG. 1, diaphragm 1 is made of kraft pulp and arched forward from inner-diameter-fixing part 1A and outer-diameter-fixing part 1B. Top part 1C of the diaphragm forms a top part protruding forward from inner-diameter-fixing part 1A and outer-diameter-fixing part 1B. Diaphragm 1 is formed in curved surface from inner-diameter-fixing part 1A through top part 1C of the diaphragm to outer-diameter-fixing part 1B.

Outer-diameter-fixing part 1B is coupled with edge 6 made of cloth. Edge 6 is coupled with frame 5, thereby coupling diaphragm 1 with frame 5. Inner-diameter-fixing part 1A is coupled with voice coil 3, thereby forming a joining portion. Half apical angle θ₁ which is an angle coupling diaphragm 1 with voice coil 3 is not larger than 45 degrees. An outer periphery part of voice coil 3 is held at its center by damper 4. Further, damper 4 is fixed to frame 5. Still further, center cap 2 is fixed to a top part of voice coil 3.

Yet further, as a magnetic circuit, field magnet part 7 structured by a plate, a magnet and a yoke, is disposed at a bottom of frame 5. Voice loading coil 3A wound at a lower part of voice coil 3 is inserted and placed in magnetic gap 8 structured by the plate and the yoke.

Operation of speaker 30 structured discussed above is described hereinafter.

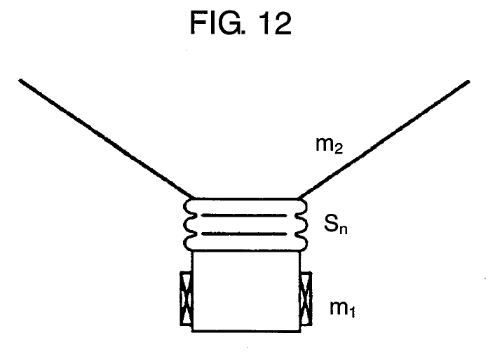

Relation between high threshold frequency Fh of a speaker and half apical angle θ is disclosed in document 1. In a word, in a case of a model of the speaker shown in FIG. 12, the relation between high threshold frequency Fh and half apical angle θ is expressed by following formula 1.

$$\begin{matrix}Fh = \frac{1}{2 π} \sqrt{( \frac{1}{{m}_{1}} + \frac{1}{{m}_{2}} ) \cdot Sn} \\ = \frac{1}{2 π} \sqrt{( \frac{1}{{m}_{1}} + \frac{1}{{m}_{2}} ) \cdot \frac{π \cdot E \cdot h \cdot {cos}^{2} θ}{sin θ}}\end{matrix} \qquad formula 1$$

m₁: mass of a voice coil [kg]

m₂: mass of a diaphragm [kg]

Sn: stiffness of a base of a diaphragm=π·E·h·cos² θ/sin θ

E: Young's modulus of the diaphragm [N/m²]

h: a thickness of the base of the diaphragm [m]

θ: a half apical angle of the diaphragm [deg]

In short, it is effective to make half apical angle θ small for extending high threshold frequency Fh. However, in general, small half apical angle θ makes a total height of the diaphragm higher. In addition, small half apical angle θ generates gentle-and-large peaks and dips at a sound-pressure-frequency characteristic by anterior-chamber effect of forward space ranging from a front surface of the diaphragm to a fixing part of the diaphragm. Accordingly, the speaker having half apical angle θ larger than 45 degrees is common.

On the contrary, because diaphragm 1 is formed in curved surface, forward space from a front surface of diaphragm 1 to top part 1C of the diaphragm is small, even when half apical angle θ1 is not larger than 45 degrees. Further, strength of diaphragm 1 can be improved by controlling a curving state of diaphragm 1. As a result, thinner speaker 30 can be realized, and generation of dividing resonance of diaphragm 1 is restricted.

In a case where the diaphragm is made of single material, if the material is soft, stiffness of the diaphragm becomes insufficient, so that reproduction at a high frequency band becomes difficult. On the other hand, if the material is hard, flexibility becomes insufficient, so that reproduction at a low frequency band becomes difficult. In a word, reproduction of sound-pressure-frequency at broad bands ranging from a low band to a high band is difficult.

However, edge 6 is fixed to outer-diameter-fixing part 1B, thereby coupling diaphragm 1 with frame 5. Edge 6 is made of cloth or the like different material from diaphragm 1. Because material having Young's modulus lower than that of diaphragm 1 is used in edge 6, vibration at a low frequency band is difficult to be attenuated. If edge 6 has a shape in such a manner that vibration at a low frequency band is difficult to be attenuated, it is more effective. By using this structure, amplitude for reproducing a low frequency is secured. In short, a high reproducing threshold frequency is extended by the material, shape and half apical angle of diaphragm 1. In addition, reproduction of the low frequency is realized by using edge 6. Therefore, frequencies at broad bands ranging from a low frequency to a high frequency are reproduced as a flat frequency characteristic.

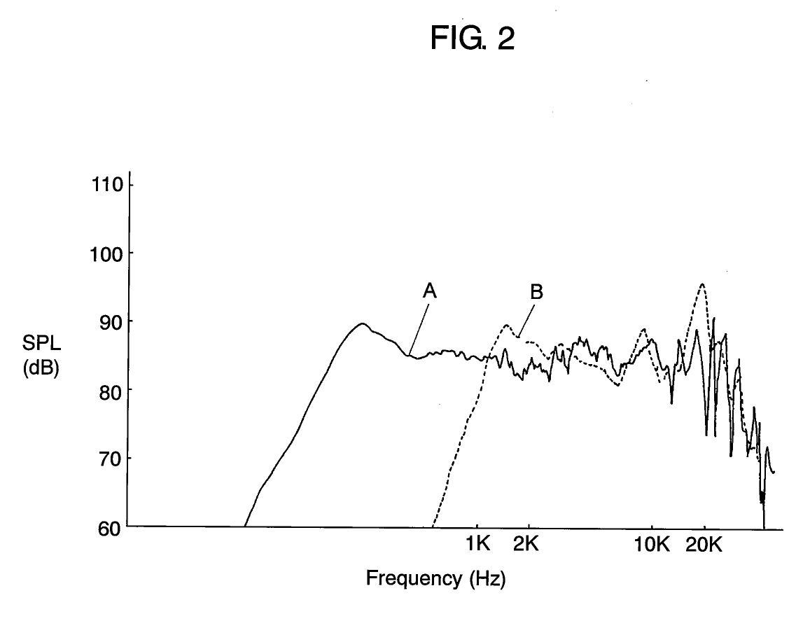

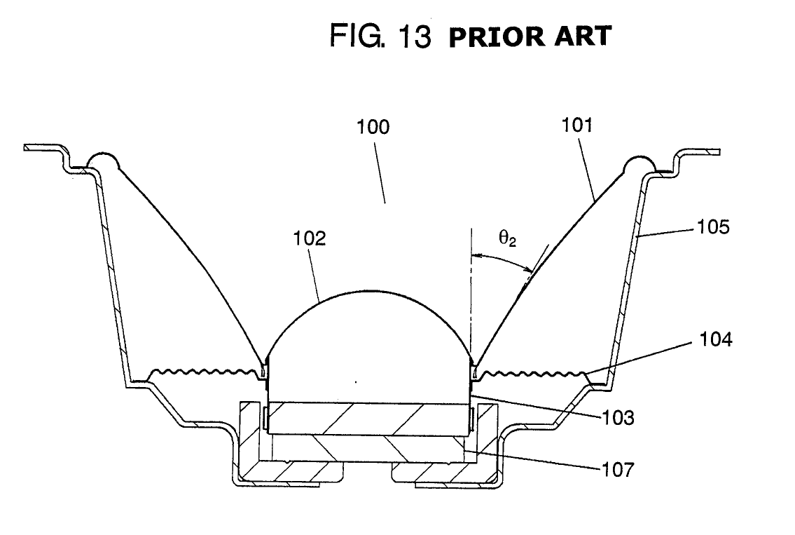

Measured sound-pressure-frequency characteristics are demonstrated hereinafter with reference to its characteristic view. FIG. 2 shows the sound-pressure-frequency characteristics comparing speaker 30 of the present invention shown in FIG. 1 with conventional speaker 100 shown in FIG. 13. Half apical angle θ₂ and weight of diaphragm 101 of speaker 100 are the same as those of speaker 30.

According to the sound-pressure-frequency characteristic of speaker 100 in FIG. 2, peaks and dips caused by anterior-chamber effect occur in the vicinity of 3-12 kHz as shown at characteristic curve B. Furthermore, by reducing strength of diaphragm 101, a lot of large peaks and dips occur at frequency bands not less than 15 kHz caused by dividing resonance of diaphragm 101. In addition, because an outer periphery part of diaphragm 101 is fixed to frame 105 directly, the lowest resonance frequency F₀ becomes high (i.e., 1.5 kHz).

On the other hand, as shown at characteristic curve A of the sound-pressure-frequency characteristic of speaker 30, high threshold frequency is high enough (i.e., 30 kHz) and exceeds audible frequency bands. Further, peaks and dips caused by anterior-chamber effect or dividing resonance of diaphragm 1 are reduced considerably. Still further the lowest resonance frequency F₀ is 200 Hz, which is extremely low as compared with the characteristic of speaker 100.

As discussed above, according to speaker 30 of the present invention, diaphragm 1 has an arched shape, so that diaphragm 1 can be thinner even when half apical angle θ₁ is small. Therefore, anterior-chamber effect is restricted. Further, strength of diaphragm 1 improves, so that dividing vibration is difficult to be generated. As a result, speaker 30 itself can be thinner. In addition, the high threshold frequency extends and the sound-pressure-frequency characteristic flattens. In addition, by fixing outer-diameter-fixing part 1B to edge 6 made of soft material, the lowest resonance frequency of speaker 30 extends to a low frequency area. By using this structure, the sound-pressure-frequency characteristic can be flattened over broad frequency bands.

According to the first embodiment, kraft pulp is used as material of diaphragm 1. However, material of diaphragm 1 is not limited to this, and diaphragm 1 may be formed with wood fiber including sulfite pulp alone or combination of kraft pulp and sulfite pulp. Further, reinforcing agent (e.g., mica, carbon or animal fiber such as wool) may be mixed in wood fiber. Still further, the same effect can be obtained by using material such as film.

Cloth is used as material of edge 6. However, material of cloth is not limited to this. Material different from material of diaphragm 1 can be used as material of edge 6. For example, the same effect can be obtained by using material such as rubber or urethane.

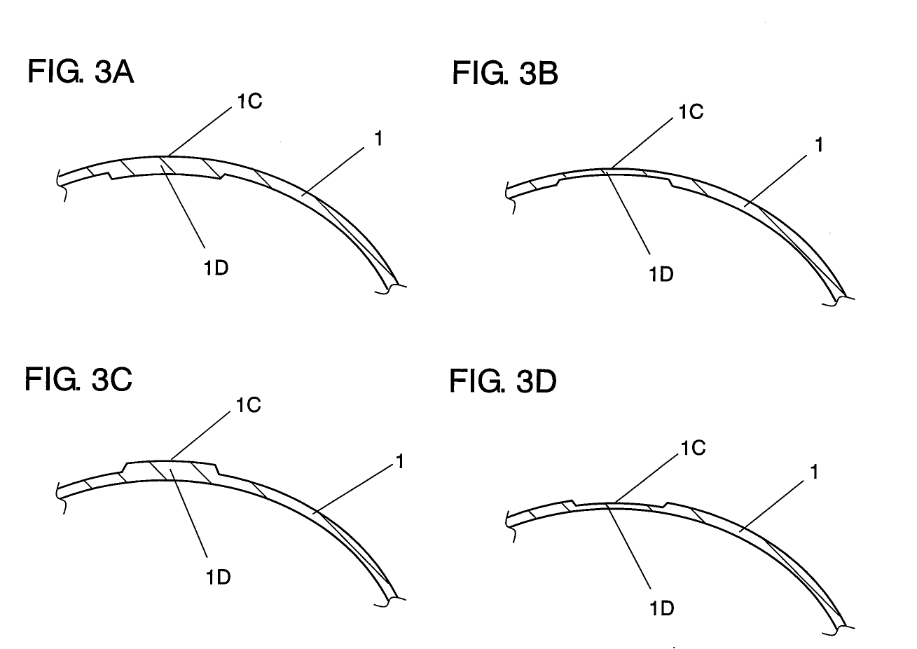

Speaker 30 may have diaphragm 1 shown in FIG. 3 through FIG. 8. As shown in FIG. 3 through FIG. 8, part 1D near the top part formed near top part 1C of diaphragm 1 differs from a part other than part 1D near the top part of diaphragm 1 in thickness or density. In a word, at least one of thickness and density of the material at part 1D near the top part is changed.

For example, as shown in FIG. 3A and FIG. 3C, the thickness of the material of part 1D near the top part can be increased in diaphragm 1. Either side of a back surface side (shown in FIG. 3A) or a front surface side (shown in FIG. 3C) of speaker 30 may be adapted for a direction to thicken the material. Besides, as shown in FIG. 3B and FIG. 3D, the thickness of the material of part 1D near the top part can be reduced in diaphragm 1. Either side of a back surface side (shown in FIG. 3B) or a front surface side (shown in FIG. 3D) of speaker 30 may be adapted for a direction to reduce the thickness of the material.

As discussed above, the thickness of the material of part 1D near the top part differs from that of a part other than part 1D near the top part of diaphragm 1. Therefore, the sound-pressure-frequency characteristic, which speaker 30 reproduces, can be flattened further. Whether the thickness of the material of part 1D near the top part increases or decreases is determined by relation of constructional elements such as diaphragm 1, voice coil 3, and frame 5, which compose speaker 30.

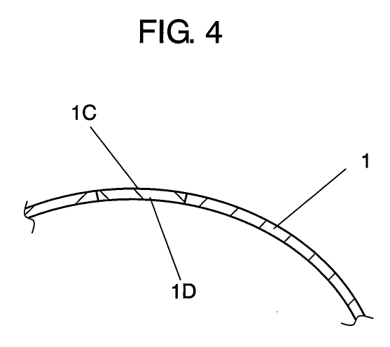

As shown in FIG. 4, density of the material of part 1D near the top part of diaphragm 1 can be lower than the other part thereof. By using this structure, the sound-pressure-frequency characteristic, which speaker 30 reproduces, can be flattened further. The density of the material of part 1D near the top part of diaphragm 1 may be higher than the other part thereof. Whether the density of the material of part 1D near the top part is made higher or lower is determined by relation of constructional elements, which compose speaker 30.

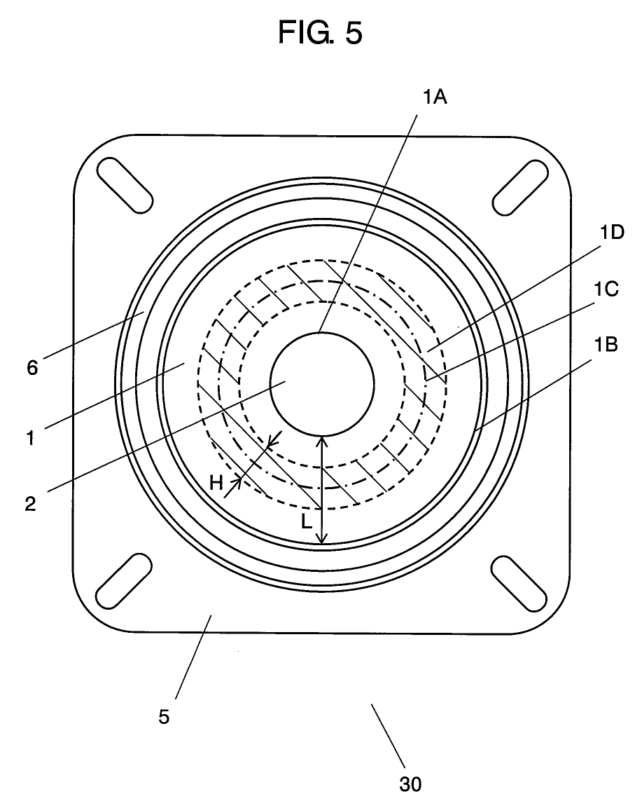

As shown in FIG. 5, part 1D near the top part may be formed at an entire periphery of diaphragm 1. Here a distance between inner-diameter-fixing part 1A and outer-diameter-fixing part 1B is defined as “L”, and a width of part 1D near the top part is defined as “H”. Effect of flattening sound-pressure-frequency characteristics, which speaker 30 reproduces, can be obtained in a range of H=0.9L in relation between “L” and “H”. The effect of flattening can be preferably obtained in a range of H=0.5L. The effect of flattening can be more preferably obtained in a range of H=0.3L. Width H of part 1D near the top part is determined by relation of constructional elements, which compose speaker 30.

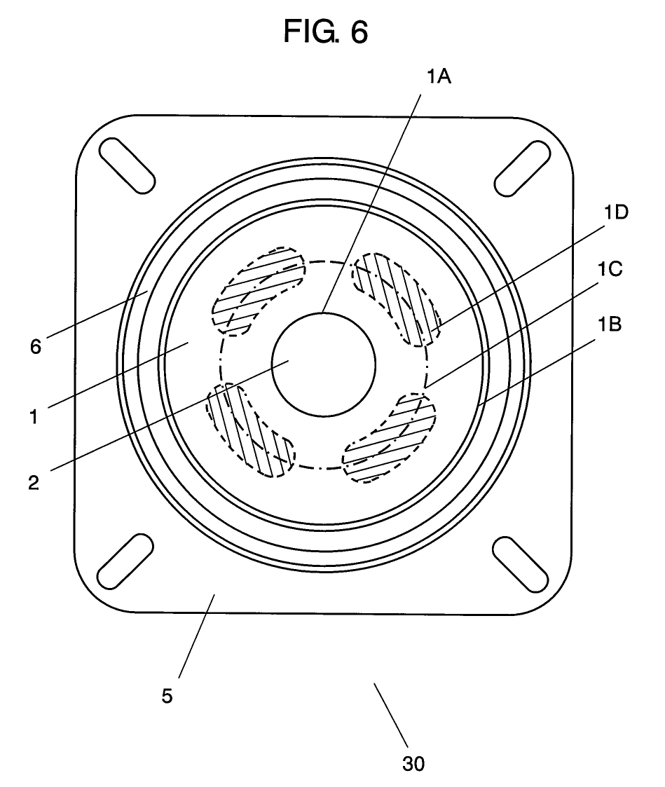

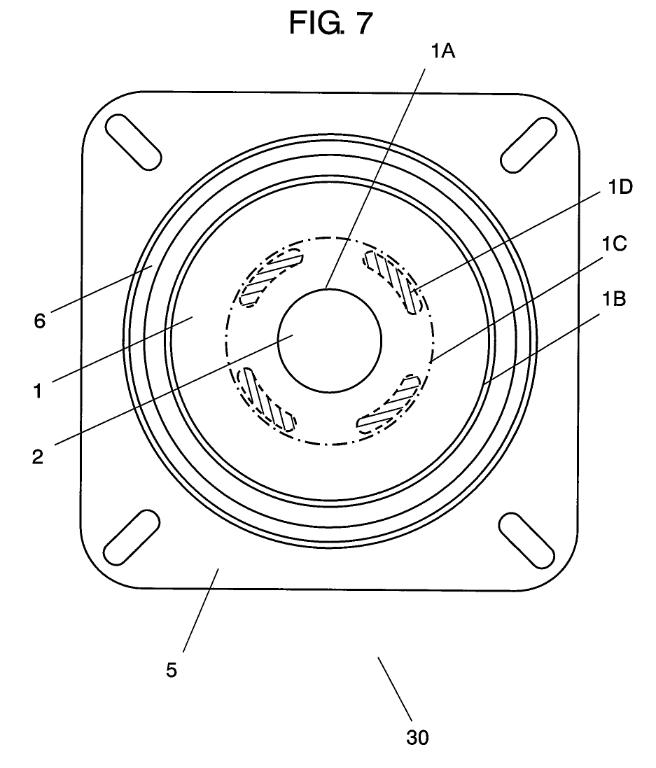

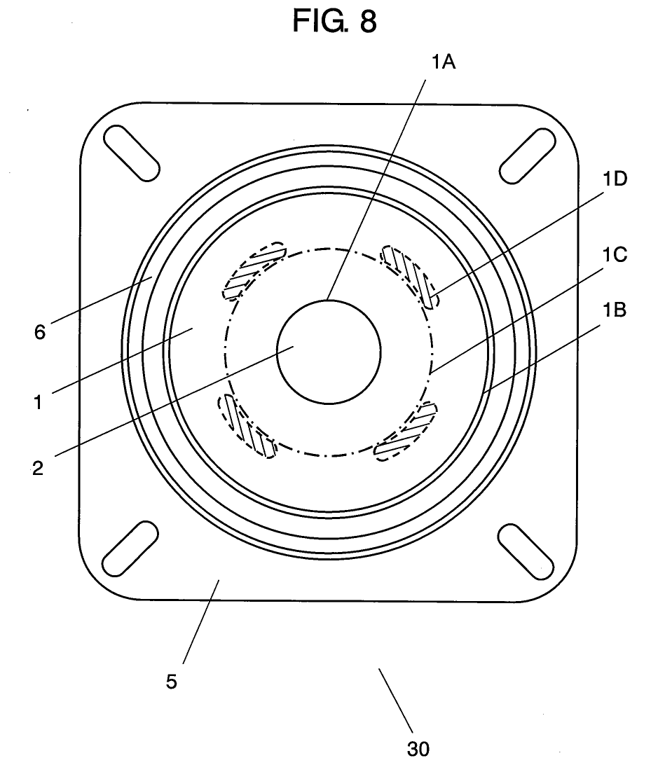

As shown in FIG. 6 through FIG. 8, part 1D near the top part may be formed at a part near top part 1C of the diaphragm. Besides, as shown in FIG. 7 through FIG. 8, part 1D near the top part may not necessarily include top part 1C of the diaphragm. As discussed above, a position or a range where part 1D near the top part is formed is determined by relation of constructional elements, which compose speaker 30. Here part 1D differs from the other part in thickness or density.

In addition, the thickness or the density of the material at part 1D near the top part can be changed drastically, or can be changed gradually with gradation.

### SECOND EXEMPLARY EMBODIMENT

The second embodiment is demonstrated hereinafter with reference to the accompanying drawings.

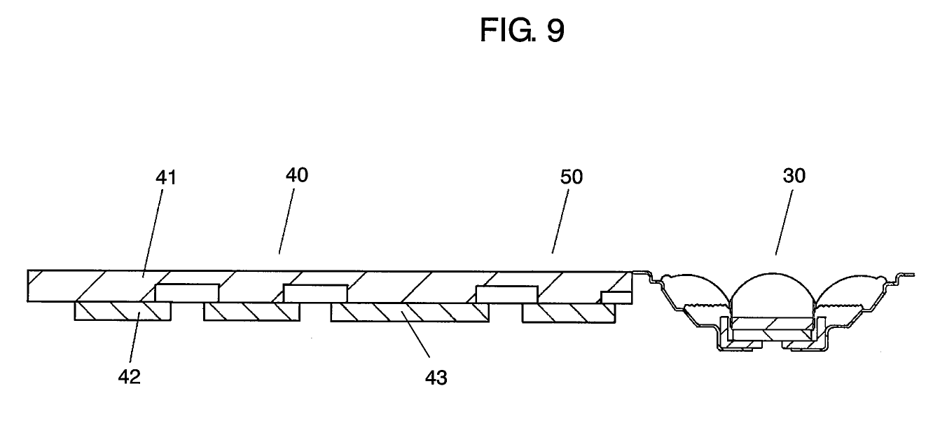

FIG. 9 is a sectional view of a speaker module in accordance with the second exemplary embodiment.

As shown in FIG. 9, speaker module 50 of the second embodiment has a structure integrating speaker 30 shown in the first embodiment into electronic circuit 40. Detailed description of speaker 30 is omitted here.

Electronic circuit 40 as a main body is structured by fixing and wiring electronic component 42 to circuit board 41. Further, electronic circuit 40 includes amplifier circuit 43 amplifying a voice signal to be supplied to speaker 30. In a word, amplifier circuit 43 is a circuit amplifying the voice signal processed to a sound pressure level which is necessary for outputting it from speaker 30. Amplifier circuit 43 has been integrated into speaker 30 and wired internally. Therefore, a voice output can be easily obtained by coupling speaker module 50 with a voice signal generator (not shown).

Further, electronic circuit 40 may include an additional device such as a voice signal generator or a display circuit besides amplifier circuit 43. For example, in a case of a communication device such as a portable phone, various circuits such as a circuit necessary for communication (e.g., a detecting circuit, a modulating circuit or a demodulating circuit), a driving circuit for a display means (e.g., liquid crystal), a power supply circuit, or a charging circuit can be included.

Using the structure discussed above, speaker 30 and electronic circuit 40, both of which had produced separately and supplied to a production center of an electric device such as a portable phone via an inspection process or a physical distribution process, are integrated each other and modularized. Therefore, a production process, an inspection process and a physical distribution process are integrated, so that tremendous cost reduction is performed.

Accordingly, inexpensive speaker module 50 where speaker 30 and electronic circuit 40 are coupled with each other is provided.

### THIRD EXEMPLARY EMBODIMENT

The third embodiment is demonstrated hereinafter with reference to the accompanying drawings.

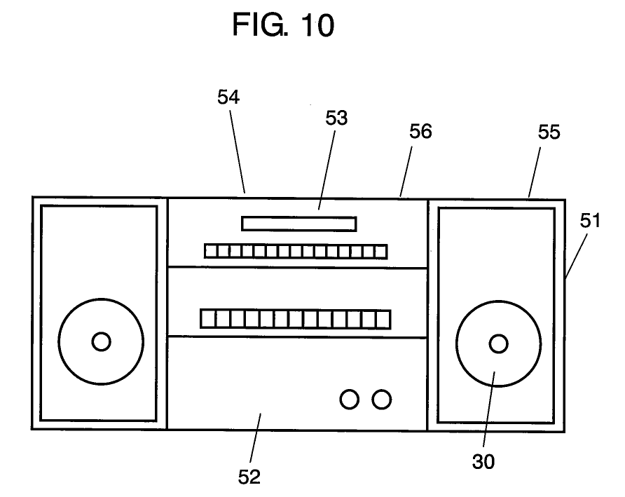

FIG. 10 is an outline view of a mini component system for audio as an electric device in accordance with the third exemplary embodiment of the present invention.

As shown in FIG. 10, speaker 30 as an electro-acoustic transducer is incorporated in enclosure 51, so that speaker system 55 is structured. Amplifier 52 is an amplifier circuit, which amplify an electric signal to be input to speaker 30. Player 53 outputs a source to be input to amplifier 52. Amplifier 52 and player 53 structure main body 56. Mini component system 54 for audio, which is an electric device, is structured by speaker system 55 and main body 56. In a word, an electric power is supplied from main body 56 to speaker 30.

Using the structure discussed above, a device, which is an excellent electric device capable of reproducing sound-pressure-frequency bands ranging broad bands and was not realized conventionally, can be realized not by using plural kinds of speakers having various sound-pressure-frequency characteristics but by using only speaker 30.

Speaker 30 is not limited to be used in component system 54, and can be mounted on various acoustic devices, image devices, communication devices or the like. In a word, it has extremely broad uses in a liquid crystal TV, a plasma display TV, a portable phone or the like.

In addition, height of diaphragm 1 is low, so that the speaker can be thinner. Therefore, an electric device can be thinner and smaller.

### FOURTH EXEMPLARY EMBODIMENT

The fourth embodiment is demonstrated hereinafter with reference to the accompanying drawings.

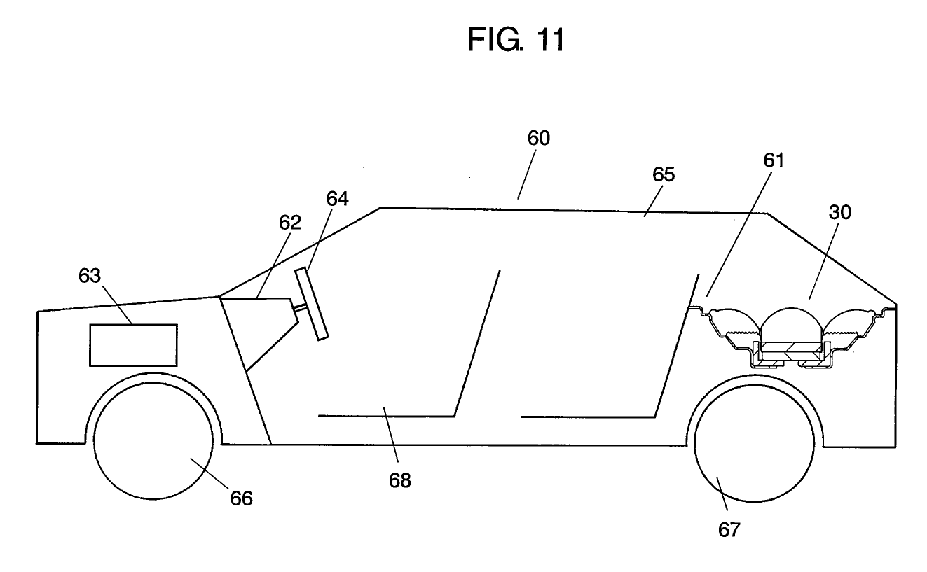

FIG. 11 is a sectional view of automobile 60 as a device in accordance with the fourth exemplary embodiment of the present invention. As shown in FIG. 11, automobile 60 includes body 65, seat 68, driving member 63, steering 64, front wheel 66 and rear wheel 67. Seat 68 and steering 64 are placed at a vehicle interior positioned in body 65, and driving member 63 is placed at an engine room positioned in body 65. Steering 64 operates front wheels 66 which are steering wheels. Driving member 63 includes an engine or motors, and drives rear wheels 67 which are drive wheels. Driving member 63 may drive front wheels 66. Front wheel 66 and rear wheel 67 support body 65. Speaker 30 is incorporated into rear tray 61 positioned in body 65 of automobile 60, and used as a part of a car navigation system or a car audio system. In a word, an electric power is supplied from automobile 60 as a main body to speaker 30.

Using the structure discussed above, because speaker 30 which is made thinner and smaller is used, a device such as automobile 60 at which speaker 30 is mounted can be thinner and smaller or free space inside the device can be expanded.

Speaker 30 can be mounted not only at rear tray 61, but also at every place such as front panel 62, a door (not shown), or a side panel (not shown) in automobile 60.

Automobile 60 is described as a device mounting speaker 30, however, the device is not limited to automobile 60, and the same effect can be obtained by using other transporting means such as a bicycle, a motorcycle, a train or an airplane.

### INDUSTRIAL APPLICABILITY

A speaker, a speaker module, an electric device and a device of the present invention can be adapted to an electric device such as an image acoustic device, an information communication device or a game device, and a device such as an automobile, both of which are desired to be thinner and smaller.

1. A speaker comprising:
a frame at which a magnetic circuit is mounted;
a cylindrical voice coil whose part is placed at a magnetic gap formed by the magnetic circuit;
an arched diaphragm coupled with the voice coil; and
an edge linking the diaphragm with the frame and made of material different from that of the diaphragm,
wherein the diaphragm includes:
an inner-diameter-fixing part joined with an end of the voice coil and forming a joining portion whose half apical angle is not larger than 45 degrees;
an outer-diameter-fixing part joined with the edge; and
a top part formed between the inner-diameter-fixing part and the outer-diameter-fixing part, and protruding forward from the inner-diameter-fixing part and the outer-diameter-fixing part,
wherein a part near the top part is changed in at least one of thickness and density.

2. The speaker of claim 1,
wherein material of the diaphragm is wood fiber.

3. The speaker of claim 2,
wherein the wood fiber includes at least one of kraft pulp, sulfite pulp and material combing kraft pulp and sulfite pulp.

4. The speaker of claim 1,
wherein material of the edge is cloth.

5. The speaker of claim 1,
wherein material of the edge is rubber.

6. The speaker of claim 1,
wherein material of the edge is urethane.

7. The speaker of claim 1,
wherein material of the diaphragm includes animal fiber.

8. The speaker of claim 1,
wherein material of the diaphragm includes reinforcing agent.

9. A device comprising:
a main body; and
a speaker placed at the main body and including:
a frame at which a magnetic circuit is mounted;
a cylindrical voice coil whose part is placed at a magnetic gap formed by the magnetic circuit;
an arched diaphragm coupled with the voice coil; and
an edge linking the diaphragm with the frame and made of material different from that of the diaphragm,
wherein the diaphragm includes:
an inner-diameter-fixing part joined with an end of the voice coil and forming a joining portion whose half apical angle is not larger than 45 degrees;
an outer-diameter-fixing part joined with the edge; and
a top part formed between the inner-diameter-fixing part and the outer-diameter-fixing part, and protruding forward from the inner-diameter-fixing part and the outer-diameter-fixing part,
wherein a part near the top part is changed in at least one of thickness and density.

10. The device of claim 9,
wherein the main body includes a circuit for amplifying an input signal to the speaker.

11. The device of claim 9,
wherein the main body includes
a body;
a driving member placed at the body;
a drive wheel driven by the driving member and supporting the body;
a steering placed at the body;
a steering wheel operated by the steering,
wherein the speaker is placed at the body.
